(19) United States
(12) Patent Application Publication
(10) Pub. No.: US 2003/0035963 A1
(43) Pub. Date: Feb. 20, 2003

(54) Adhesive composition for the cementing of a floor covering, particularly suited for use in aviation, floor covering, and method of making floor covering

(76) Inventor: Lutz Polozek, Wunstorf (DE)

Correspondence Address: SHLESINGER, ARKWRIGHT & GARVEY LLP, 3000 South Eads Street, Arlington, VA, 22202, US

(21) Appl. No.: 10/218,455

(22) Filed: Aug. 15, 2002

(30) Foreign Application Priority Data
Aug. 16, 2001 (DE) 101 39 189.7-43

(51) Int. Cl. B32B 15/04

(52) U.S. Cl. 428/423.1; 428/343; 428/425.5; 428/414; 428/921

(57) ABSTRACT

Adhesive composition for the cementing of a surface layer of a floor covering with a carrier layer of a floor covering includes, a crosslinking adhesive and an antimony- and halogen-free flameproofing agent. The adhesive composition and floor covering are particularly suited for aviation. The fraction of the flameproofing agent may be at least 5% by weight of the adhesive composition. The flameproofing agent may contain ammonium polyphosphate. The adhesive composition makes possible, in a simple and low-cost manner, a cementing of the surface layer with the carrier layer, wherein the requirement of its being highly flame-resistant is accounted for. Moreover, when using the adhesive composition in accordance with the invention, values with regard to combustion gas density and the release of toxic agents clearly fall below acceptable limits governing aviation in cases of fire so that the floor covering is completely suitable for aviation.

### CROSS REFERENCE TO RELATED APPLICATION

This application claims the priority of German Application No. 101 39 189.7-43, filed Aug. 16, 2001, which is incorporated herein by reference.

### FIELD OF THE INVENTION

The invention concerns an adhesive composition for the cementing of a surface layer of a floor covering with a carrier layer of the floor covering, intended for use in aviation.

More particularly, the invention relates to a method of making a floor covering particularly suited for use in aviation, and a floor covering suited for use in aviation.

### BACKGROUND OF THE INVENTION

In aviation, for example, floor coverings used on board airplanes frequently consist of a surface layer, for example made of polyvinylchloride (PVC), and a carrier layer, for example consisting of a phenol resin laminate.

The joining of the surface layer with the carrier layer by means of a double-sided adhesive strip is known. A disadvantage of that is that during the flight, there is a formation of bubbles, as the external air pressure declines; in other words, air enclosed in the adhesive strip and/or between the adhesive strip and the layers of the floor covering expands. In this way, damaged and buckled portions (“stumbling traps”) develop in the floor covering, so that the floor covering, under certain circumstances, must be replaced before the expiration of the theoretical service time, e.g., useful life.

An additional disadvantage is that there is the danger that the material shrinks on the carrier material after the surface material has been installed so as to fit exactly with a built-in component in the plane.

The joining of the surface layer with the carrier layer, using a “pressure-sensitive adhesive” is also known. Here, the same disadvantages exist as with the use of double-sided adhesive strips.

### OBJECTS AND SUMMARY OF THE INVENTION

An object of the invention is to make possible a cementing of a surface layer of a floor covering, intended for use in aviation, with a carrier layer of a floor covering, in a simple, low-cost, and reliable manner, wherein the suitability of the end product in aviation applications is ensured.

This object is achieved by the teaching according to the invention in a surprisingly simple manner by the provision of an adhesive composition which contains a crosslinking adhesive and an antimony- and halogen-free flameproofing agent. In this way, a cementing of the surface layer is made possible in a simple and low-cost manner. A firm union of the surface layer with the carrier layer is attained by the adhesive composition because of the crosslinking adhesive, so that a shrinkage of the surface layer on the carrier layer after installation in airplane can be reliably avoided.

Another advantage of the teaching in accordance with the invention is to be found in that, as a result of the firm union between the surface layer and the carrier layer, formation of bubbles can be reliably avoided. Damage of the floor covering owing to the formation of bubbles can thus be reliably avoided also.

Another advantage of the teaching in accordance with the invention is to be found in that as a result of the flameproofing agent contained in the adhesive composition, aviation requirements that the adhesive composition be barely flammable (e.g., difficult to inflame) is taken fully into account.

Another special advantage is to be found in that values with regard to combustion gas density and the release of toxic substances in case of fire clearly fall below aviation standards when the adhesive composition in accordance with the invention is used. A floor covering produced with the use of an adhesive composition in accordance with the invention is thus suitable for aviation without any reservation.

Additional flameproofing measures after the production of the floor covering are generally not required as a result of the fact that the adhesive composition in accordance with the invention contains a flameproofing agent. This simplifies the production of the floor covering and thus enables it to be produced at a lower cost.

Relative terms such as up, down, left, and right are for convenience only and are not intended to be limiting.

### BRIEF DESCRIPTION OF THE DRAWING

FIG. 1 schematically shows an adhesive composition disposed between and adhering a surface layer of a floor covering to a carrier layer of the floor covering.

### DETAILED DESCRIPTION OF THE INVENTION

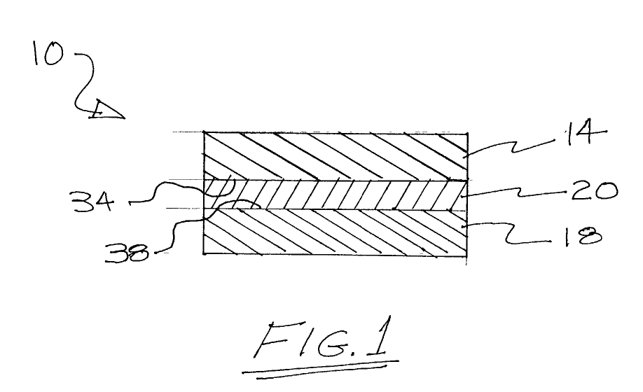

FIG. 1 illustrates, schematically, an adhesive according to the invention, its use in making a floor covering, and a floor covering made by such method, each of which may be particularly suited for use in aviation.

Specifically, a floor covering 10 may include a surface layer 14 of the floor covering, a carrier layer 18 of the floor covering, and an adhesive composition 20 disposed therebetween.

Surface layer 14 may have a surface 34 which faces an opposed facing surface 38 of carrier layer 18.

Adhesive composition 20 may be provided on one or both of opposed surfaces 34 and 38, in use.

Additional details and variations of the invention are set forth above and below.

An extraordinarily advantageous refinement of the teaching in accordance with the invention provides for the flameproofing agent to contain ammonium polyphosphate. In this way, a particularly more effective flameproofing is attained and, in case of fire, the combustion gas density and the amount of released toxic substances are particularly low.

Basically, with the aforementioned embodiment, it is sufficient that ammonium polyphosphate be used as the only flameproofing agent. If necessary, in accordance with individual requirements, the adhesive composition can, however, contain at least one other flameproofing agent, for example, aluminum trihydroxide, a melamine derivative, or a phosphonate. In this way, flameproofing is also improved. Furthermore, in case of fire, both the combustion gas density and the amount of released toxic substances are reduced further.

The fraction of the flameproofing agent or the flameproofing agents in the adhesive composition may be at least about 5% by weight. In this way, a flameproofing which complies with aviation requirements is attained, and which flameproofing can be improved further by increasing the amount of the flameproofing agent.

The ammonium polyphosphate is appropriately present in the form of a powder.

Another appropriate refinement of the teaching of the invention provides for the flameproofing agent to be an intumescing agent. Such an intumescing agent provides for the formation of foam in the adhesive composition, thereby hindering the spreading of the fire, as well as hindering the release of combustion gases, in the case of fire.

Basically, any crosslinking adhesive can be used in the adhesive composition in accordance with the invention. An advantageous refinement provides for the adhesive to be a polyurethane adhesive. Such adhesives are low-cost and make possible a particularly reliable cementing of the surface layer with the carrier layer.

In accordance with another refinement, the adhesive is a rubber-based adhesive, in particular, a silicone rubber-based.

Another refinement provides for the adhesive to be a two-component adhesive. Such adhesives are low-cost and can be simply and easily processed.

Basically, the adhesive composition in accordance with the invention can be present in any consistency, for example, in a pasty consistency. In order to simplify the processing of the adhesive composition in accordance with the invention it is expedient that the adhesive composition be in the form of a liquid dispersion.

In order to make possible and promote a crosslinking of the adhesive, it is expedient that the adhesive composition contain a crosslinking agent, in particular, isocyanate.

In order to suppress combustion gases which form in the case of a fire, it is expedient that the adhesive composition in accordance with the invention contain a combustion gas suppressing agent, which can be advantageously in the form of melamine or a melamine derivative.

The use of an adhesive composition in accordance with the invention for the cementing of a surface layer of a floor covering with a carrier layer of a floor covering, intended for use in aviation, may include the steps of

a) providing a surface layer of a floor covering;

b) providing a carrier layer of a floor covering; and

c) providing an adhesive composition between the surface layer of a floor covering and the carrier layer of a floor covering, the adhesive composition including:

i) a crosslinking adhesive; and

ii) an antimony- and halogen-free flameproofing agent.

A floor covering, in accordance with the invention and intended for use in aviation, which has a surface layer and a carrier layer, may include a surface layer cemented with the carrier layer by means of an adhesive composition of the type including:

a) a surface layer;

b) a carrier layer; and

c) the surface layer being cemented to the carrier layer by an adhesive composition, the adhesive composition including:

i) a crosslinking adhesive; and

ii) an antimony- and halogen-free flameproofing agent.

Advantageous and appropriate refinements of the floor covering in accordance with the invention include:

1. a floor covering wherein the carrier layer includes a phenol resin laminate; and

2. a floor covering wherein the surface layer includes one of polyvinylchloride (PVC), polyurethane, and a thermoplastic olefin (TPO).

### EXAMPLE

A floor covering, intended for use in aviation, has an upper layer made of polyvinylchloride (PVC) and a carrier layer consisting of or including a phenol resin laminate. For the cementing of the surface layer with the carrier layer, an adhesive composition in accordance with the invention and present as a liquid dispersion is used, and which contains a polyurethane adhesive and ammonium polyphosphate as the flameproofing agent, wherein the fraction of the ammonium polyphosphate in the adhesive composition is about or is 5% by weight. The adhesive composition may also contain melamine as a combustion gas suppression agent and isocyanate as a crosslinking agent. After the application of the adhesive composition on the respective surfaces of the surface layer and the carrier layer, which respective surfaces face one another, or on only one of those respective facing surfaces, the layers are cemented with one another under the effects of pressure and heat.

After that cementing, the surface layer and the carrier layer are securely joined with one another, without the danger that the surface layer may shrink on the carrier layer or that the floor covering may be damaged by a formation of bubbles. As a result of the flameproofing agent contained in the adhesive composition, aviation requirements of low flammability are complied with. Moreover, the values with regard to combustion gas density and the release of toxic substances in case of fire clearly fall below the limiting values or limits that govern in aviation, so that the floor covering in accordance with the invention is suitable for aviation without reservation.

While this invention has been described as having a preferred design, it is understood that it is capable of further modifications, and uses and/or adaptations of the invention and following in general the principle of the invention and including such departures from the present disclosure as come within the known or customary practice in the art to which the invention pertains, and as may be applied to the central features hereinbefore set forth, and fall within the scope of the invention or limits of the claims appended hereto.

What is claimed:

1. Adhesive composition for the cementing of a surface layer of a floor covering to a carrier layer of a floor covering, intended for use in aviation, the adhesive composition comprising:
a) a crosslinking adhesive; and
b) an antimony- and halogen-free flameproofing agent.

2. Adhesive composition according to claim 1, wherein:
a) the flameproofing agent includes ammonium polyphosphate.

3. Adhesive composition according to claim 2, wherein:
a) the adhesive composition contains a further flameproofing agent; and
b) the further flameproofing agent includes one of aluminum trihydroxide, a melamine derivative, and a phosphonate.

4. Adhesive composition according to claim 1, wherein:
a) a fraction of the flameproofing agent in the adhesive composition is at least about 5% by weight.

5. Adhesive composition according to claim 2, wherein:
a) the ammonium polyphosphate is in a powder form.

6. Adhesive composition according to claim 1, wherein:
a) the flameproofing agent includes an intumescing agent.

7. Adhesive composition according to claim 1, wherein:
a) the cross-linking adhesive includes a polyurethane adhesive.

8. Adhesive composition according to claim 1, wherein:
a) the cross-linking adhesive includes one of a rubber-based adhesive and a silicone rubber-based adhesive.

9. Adhesive composition according to claim 1, wherein:
a) the cross-linking adhesive includes a two-component adhesive.

10. Adhesive composition according to claim 1, wherein:
a) the adhesive composition is in the form of a liquid dispersion.

11. Adhesive composition according to claim 1, wherein:
a) a cross-linking agent is provided.

12. Adhesive composition according to claim 11, wherein:
a) the cross-linking agent is an isocyanate.

13. Adhesive composition according to claim 1, wherein:
a) a combustion gas suppression agent is provided.

14. Adhesive composition according to claim 13, wherein:
a) the combustion gas suppression agent includes at least one of melamine and a melamine derivative.

15. A method of making a floor covering for use in aviation, comprising:
a) providing a surface layer of a floor covering;
b) providing a carrier layer of a floor covering; and
c) providing an adhesive composition between the surface layer of a floor covering and the carrier layer of a floor covering, the adhesive composition including:
i) a crosslinking adhesive; and
ii) an antimony- and halogen-free flameproofing agent.

16. A method according to claim 15, wherein:
a) the adhesive composition includes a combustion gas suppression agent.

17. A floor covering for use in aviation, comprising:
a) a surface layer;
b) a carrier layer; and
c) the surface layer being cemented to the carrier layer by an adhesive composition, the adhesive composition including:
i) a crosslinking adhesive; and
ii) an antimony- and halogen-free flameproofing agent.

18. A floor covering according to claim 17, wherein:
a) the carrier layer includes a phenol resin laminate.

19. A floor covering according to claim 17, wherein:
a) the surface layer includes one of polyvinylchloride (PVC), polyurethane, and a thermoplastic olefin (TPO).
